(19) United States
(12) Patent Application Publication
(10) Pub. No.: US 2008/0024627 A1
(43) Pub. Date: Jan. 31, 2008

(54) Image display apparatus, image taking apparatus, image display method, and program

(75) Inventor: Kenji Nozawa, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/826,707

(22) Filed: Jul. 18, 2007

(30) Foreign Application Priority Data
Jul. 25, 2006 (JP) 2006-202124

(51) Int. Cl. H04N 5/76

(52) U.S. Cl. 348/231.6

(57) ABSTRACT

The present invention provides an image display apparatus including a storage section which stores image data and a display section which is capable of displaying at least image data in the storage section, the image display apparatus comprising: a face information detection section which detects face information including a face area and the tilt of the face area from image data in the storage section; an instruction section to which an instruction to start face rotation can be input; and a display control section which, in response to input of an instruction to start face rotation to the instruction section, provides control so as to rotate the image data in a direction which makes the face area virtually correctly oriented based on the tilt of the face area detected by the face information detection section and displays the image data on the display section.

### BACKGROUND OF THE INVENTION

1. Field of the Invention

The present invention relates to an image display apparatus having the function of rotating an image in accordance with the tilt of a face.

2. Description of the Related Art

Techniques are known that automatically determine the correct orientation of an image. For example, Japanese Patent Application Laid-Open No. 08-138024 discloses a technique for extracting the face of a person in an image as well as his arms and legs, and determining the orientation of the image based on the positional relationships among them.

The technique described in Japanese Patent Application Laid-Open No. 08-138024 may automatically determine a position which is not intended by the user to be a correct orientation even though the image is already positioned in a correct orientation, for example. The present invention has been made in view of such a drawback and has an object of rotating an image in a correct direction in conformity with the user's intention.

### SUMMARY OF THE INVENTION

The present invention relates to an image display apparatus that includes a storage section which stores image data and a display section which is capable of displaying at least image data in the storage section.

The image display apparatus includes a face information detection section which detects face information including a face area and the tilt of the face area from image data in the storage section; an instruction section to which an instruction to start face rotation can be input; and a display control section which, in response to input of an instruction to start face rotation to the instruction section, provides control so as to rotate the image data in a direction which makes the face area virtually correctly oriented based on the tilt of the face area detected by the face information detection section and displays the image data on the display section.

According to the invention, since image data is rotated in a direction which makes a face area virtually correctly oriented in response to input of an instruction to start face rotation, it is possible to prevent an image from being automatically rotated regardless of the user's intention.

The display control section may also provide control so as to rotate the image data in a direction which makes the face area virtually correctly oriented and display the image data on the display section only when the tilt of the face area exceeds a predetermined angle.

This can leave an image unrotated when a person in the image is already in a virtually correct orientation.

When the face information detection section detects a plurality of face areas and multiple pieces of face information, the display control section may provide control so as to rotate the image data in a direction that virtually correctly orients the majority of the face areas and display the image data on the display section.

Thus, when only one of subjects is in a lying position in a landscape image, for example, it is possible to prevent the image from being rotated in a direction which makes the lying subject look like standing.

When an image contains the same number of face areas that have different correct orientations, the image may be rotated with respect to either of the orientations.

The image display apparatus may further include a selection section which, when the face information detection section detects a plurality of face areas and multiple pieces of face information, allows selection of a desired one of the faces, wherein the display control section may provide control so as to rotate the image data in a direction which makes the face area selected through the selection section virtually correctly oriented and display the image data on the display section.

This enables an image to be rotated so that a desired face in the image is correctly oriented and prevents an image from being rotated based on a wrong piece of face information which is obtained from, for example, a poster showing a person or a doll included in the image.

“Being virtually correct orientated” means a state in which the top of the head of a face area is displayed in the upper portion of the display section and the chin is in the lower portion of the display section, for example. In addition, “being virtually correctly oriented” does not necessarily require that the midline of a face area is perfectly parallel with the perpendicular line, but a certain tilt is allowed. For example, when the top of the head of a face area is displayed in the upper portion of the display section and the chin is displayed in the lower portion of the display section and an acute angle formed between the midline of the face area and the perpendicular line is less than 45 degrees, this condition is also included in “being virtually correctly oriented”.

The present invention also includes an image taking apparatus that has the image display section described above.

An image display method according to the invention includes the steps of: detecting face information including a face area and the tilt of the face area from image data; inputting an instruction to start face rotation; and in response to input of an instruction to start face rotation, rotating the image data in a direction which makes the face area virtually correctly oriented based on the detected tilt of the face area and displaying the image data.

An image display program according to the invention causes a computer to execute the steps of: detecting face information including a face area and the tilt of the face area from image data; inputting an instruction to start face rotation; and in response to input of an instruction to start face rotation, rotating the image data in a direction which makes the face area virtually correctly oriented based on the detected tilt of the face area and displaying the image data.

According to the present invention, since image data is rotated in a direction which makes a face area virtually correctly oriented in response to input of an instruction to start face rotation, it is possible to prevent an image from being automatically rotated regardless of the user's intention.

### BRIEF DESCRIPTION OF THE DRAWINGS

FIG. 1 is a front view of a digital camera;

FIG. 2 is a rear view of the digital camera;

FIG. 3 is a block diagram of the digital camera;

FIG. 4 conceptually shows programs executed by a main CPU according to a first embodiment;

FIG. 5 is a flowchart showing the flow of image display processing according to the first to fifth embodiments;

FIGS. 6A, 6B, 6C and 6D show an example of an image which is rotated by the image display processing according to the first embodiment;

FIGS. 7A, 7B and 7C show an example of an image which is rotated by the image display processing according to the third embodiment; and

FIGS. 8A, 8B and 8C show an example of an image which is rotated by the image display processing according to the fourth embodiment.

### DETAILED DESCRIPTION OF THE PREFERRED EMBODIMENTS

Now, preferred embodiment of the present invention will be explained below with reference the drawings.

### First Embodiment

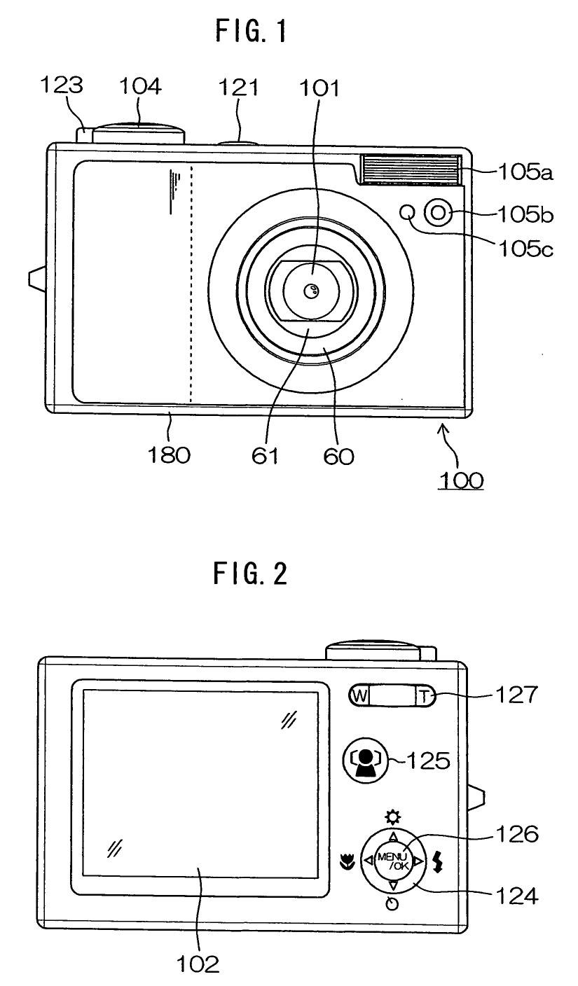

FIG. 1 is a front view showing a digital camera (hereinafter, simply referred to as camera) 100 according to a preferred embodiment of the present invention.

The camera 100 has a lens barrel 60 on the front surface thereof, and the lens barrel 60 is provided with a built-in photographing lens 101 including a zoom lens 101a and a focusing lens 101b, so that a movement of the zoom lens 101a in the direction of the optical axis enables a focal length adjustment, and also a movement of the focusing lens 101b in the direction of the optical axis enables a focus adjustment.

The lens barrel 60 advances and retracts between a wide angle end for the shortest focal length and a telephoto end for the longest focal length, both ends being set in advance, so as to be projected out of and housed in a camera body 180. In FIG. 1, the lens barrel 60 is retracted in the camera body 180.

The camera 100 is also provided with a lens cover 61 for protecting the photographing lens 101 by covering the front surface of the photographing lens 101 to shield it from the outside while the camera 100 is not operated for photographing, and for exposing the photographing lens 101 to the outside for image pickup.

The lens cover 61 is configured with an openable and closable mechanism for covering the front surface of the photographing lens 101 at its open position, and exposing the front surface of the photographing lens 101 to the outside at its closed position. The lens cover 61 is interlocked to a power button 121 to be opened/closed. In FIG. 1, the lens cover 61 is opened.

The camera 100 has a mode dial 123 provided with a central release button 104, and a power button 121 on the top surface thereof, and has an electronic flash section 105a, an AF auxiliary light lamp 105b, a self-timer lamp 105c and the like on the front surface thereof.

FIG. 2 is a back view showing the camera 100. The camera 100 has a zoom switch 127 on the rear surface thereof. A continuous pressing of a telephoto (T) side of the zoom switch 127 causes the lens barrel 60 to be projected toward the telephoto side, and a continuous pressing of the other side (W) of the zoom switch 127 causes the lens barrel 60 to move toward the wide angle side.

The camera 100 also has an image display LCD 102, a direction key 124, a face button 125, and an information position specifying key 126 on the rear surface thereof. The direction key 124 is an operation system to set a display brightness control, a self-timer, a macro photography, and a flash photography at the top, bottom, left, and right portions thereof respectively. As explained below, a pressing of the bottom key of the direction key 124 sets a self photographing mode in which a main CPU 20 causes a CCD 132 to operate a shutter operation after a clocking of the self-timer circuit 83 is completed. And a pressing of the face button 125 in setting a photographing mode starts a face detection which will be described below.

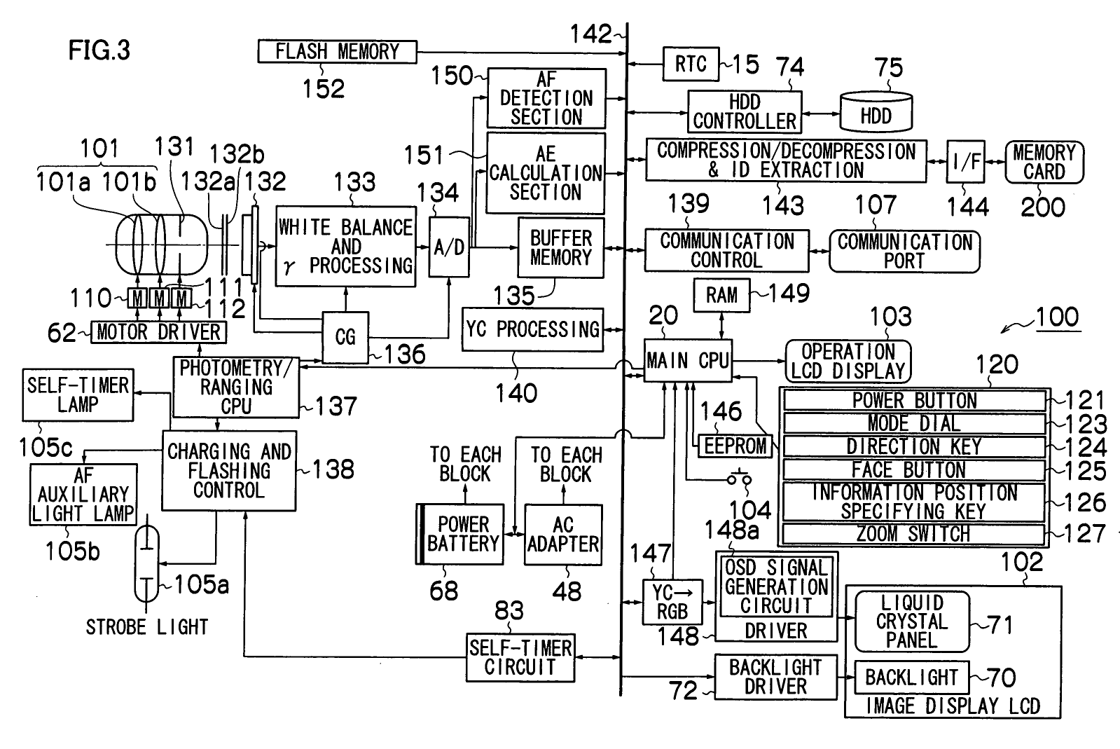

FIG. 3 is a block diagram of the camera 100 according to the first embodiment. The camera 100 is provided with an operating section 120 for various operations associated with a use of the camera 100 by a user. The operating section 120 includes a power button 121 for supplying power to operate the camera 100, a mode dial 123 for selecting an auto photography, a manual photography or the like, a direction key 124 for setting or selecting different menu or zooming, a face button 125, and an information position specifying key 126 for implementing or canceling the menu selected by the direction key 124.

The camera 100 is also provided with an image display LCD 102 for displaying a photographed image, reproduced image or the like, and an operation LCD display 103 for assisting the operations.

The camera 100 includes a release button 104. A pressing of the release button 104 informs a main CPU 20 of a start of photographing. The camera 100 is switchable between a photographing mode and a reproducing mode by using a predetermined menu screen. The camera 100 is also provided with an AF auxiliary light lamp 105b having light emitting diodes (LED) for emitting a spot light to an object in a contrast AF mode, and a flash operation device having an electronic flash section 105a for flashing light.

The camera 100 is also provided with a photographing lens 101, an aperture 131, and a CCD image sensor 132 (hereinafter, simply referred to as CCD 132) which is an image pickup element for converting the object image which is formed through the photographing lens 101 and the aperture 131 into an analog image signal. The CCD 132 generates an image signal by accumulating the charges generated by the object light incident on the CCD 132 for a variable charge storage time (exposure time). The CCD 132 sequentially outputs an image signal for each frame at a timing synchronized with the vertical synchronizing signal VD which is output from a CG section 136.

When the used image pickup element is the CCD 132, an optical lowpass filter 132a is provided thereto which removes unnecessary high frequency components in an incident light in order to prevent generation of a color error signal, moire fringe or the like. Also, an infrared cut filter 132b is provided for absorbing or reflecting the infrared rays of the incident light to correct the sensitivity characteristics inherent to the CCD sensor 132 which has a high sensitivity to a longer wavelength range. The optical lowpass filter 132a and infrared cut filter 132b may be arranged in any manner without being limited to any particular aspect.

The camera 100 is also provided with a white balance and γ processing section 133 which includes an amplifier where amplification factor is variable, for adjusting the white balance of the object image represented by the analog image signal from the CCD sensor 132, controlling the slope (γ) of the straight line in the gradient characteristics of the object image, and amplifying the analog image signal.

The camera 100 is also provided with an A/D converting section 134 for A/D converting the analog signal from the white balance and γ processing section 133 into digital R, G, and B image data, and a buffer memory 135 for storing the R, G, and B image data from the A/D converting section 134.

The R, G, and B image data obtained by the A/D converting section 134 is also input to an AF detecting section 150. The AF detecting section 150 integrates and averages the R, G, and B image data on the basis of a predetermined divided area in one screen and a color component of the screen, and further calculates the integral average values Ir, Ig, and lb of the R, G, and B image data for the entire areas for each frame. The integral average values Ir, Ig, and lb are the received amounts of visible light in R, G, and B, respectively.

However, the received amounts Ir, Ig, and lb of visible light in R, G, and B can also be detected by an optical sensor (not shown) other than CCD 132 which has sensitivities for each visible light in R, G, B.

The camera 100 is also provided with the CG (clock generator) section 136, a CPU for metering/focusing CPU 137 a charging and flashing control section 138, a communication control section 139, a YC processing section 140, and a power battery 68.

The CG section 136 outputs vertical synchronizing signals VD for driving the CCD 132, driving signals including a high speed output pulse P, control signals for controlling the white balance and γ processing section 133 and the A/D converting section 134, and control signals for controlling the communication control section 139. The CG section 136 receives control signals which are input by a metering/focusing CPU 137.

The metering/focusing CPU 137 controls a zoom motor 110, a focus motor 111, and an aperture motor for aperture adjustment 112 to drive the zoom lens 101a, focusing lens 101b, aperture 131 respectively, so that the distance to the object is calculated (focusing), and the CG section 136 and the charging and flashing control section 138 are controlled. The driving of the zoom motor 110, the focus motor 111, and the aperture motor 112 is controlled by a motor driver 62, control command for motor driver 62 is sent from the metering/focusing CPU 137 or the main CPU 20.

The driving source of the zoom lens 101a, the focusing lens 101b, the aperture 131, and the AF auxiliary light lamp 105 is not necessarily limited to various motors such as the zoom motor 110, the focus motor 111, and the aperture motor 112, and may be an actuator for example.

The metering/focusing CPU 137 measures the brightness of the object (calculation of EV value) based on the image data (through image) periodically obtained (every 1/30 seconds to 1/60 seconds) by the CCD 132 when the release button 104 is half pressed (S1 is on).

That is, an AE operation processing section 151 integrates the R, G, and B image signals output from the A/D converting section 134, and provides the resultant integrated value to the metering/focusing CPU 137. The metering/focusing CPU 137 detects an average brightness of the object (object luminance) based on the integrated value input from the AE operation processing section 151, and calculates an exposure value (EV value) which is appropriate to photographing.

Then, the metering/focusing CPU 137 determines an exposure value including an aperture value (F value) of the aperture 131 and an electronic shutter (shutter speed) of the CCD 132 based on the obtained EV value and according to a predetermined program diagram (AE operation).

A full pressing of the release button 104 (S2 is on) causes the metering/focusing CPU 137 to drive the aperture 131 based on the determined aperture value, control the diameter of the aperture 131, and control the charge storage time at the CCD 132 via the CG 136 based on the determined shutter speed.

The AE operation includes aperture priority AE, shutter speed priority AE, program AE, and the like, and either operation is controlled to pickup image with a proper exposure, by measuring an object luminance and photographing with an exposure value, that is, a combination of an aperture value and a shutter speed, which is determined based on the measured value of the object luminance. This achieves an elimination of the troublesome process to determine an exposure.

The AF detecting section 150 extracts an image data, which corresponds to the detecting range selected by the metering/focusing CPU 137, from the A/D converting section 134. A focal position is detected using the characteristics of a high frequency component in the image data which has the maximum amplitude at the focused point. The AF detecting section 150 integrates the high frequency components in the extracted image data for one field so as to calculate an amplitude value. The AF detecting section 150 serially performs the calculation of the amplitude value while the metering/focusing CPU 137 controls the focus motor 111 to drive the focus lens 101b to move within the movable range, that is between an infinite side (INF point) and a near side end (NEAR point), and sends the detected value to the metering/focusing CPU 137 when the maximum amplitude is detected.

The metering/focusing CPU 137, after obtaining the detected value, issues a command to the focus motor 111 to cause the focusing lens 101b to move to the focused position corresponding to the detected value. The focus motor 111 causes the focusing lens 101b to move to the focused position, in response to the command issued by the metering/focusing CPU 137 (AF operation).

The metering/focusing CPU 137 is connected to the release button 104 by way of the communication with the main CPU 20, and when a user presses the release button 104 halfway, the detection of a focused position is performed. The metering/focusing CPU 137 is connected to the zoom motor 110, so that when the main CPU 20 acquires a command for a zooming in the TELE direction or WIDE direction by the zoom switch 127 from a user, a driving of the zoom motor 110 allows the zoom lens 101a to move between the WIDE end and the TELE end.

The charging and flashing control section 138 charges a flashing capacitor (not shown) for flashing the electronic flash section 105a when powered by a power battery 68, and controls the flashing of the electronic flash section 105a.

The charging and flashing control section 138 controls the power supply to the self-timer lamp (tally lamp) 105c and the AF auxiliary light lamp 105b so that a desired light amount can be obtained at a desired timing, in response to the start of the charge of the power battery 68 and the receipt of various signals including the half pressed/fully pressed operation signal of the release button 104 and the signals showing the light amount and flashing timing from the main CPU 20 and the metering/focusing CPU 137.

The self-timer lamp 105c may use LEDs and the LEDs may be common to those used in the AF auxiliary light lamp 105b.

The main CPU 20 is connected to the self-timer circuit 83. When a self photographing mode is set, the main CPU 20 performs a clocking based on a fully pressed signal of the release button 104. During the clocking, the main CPU 20 causes the self-timer lamp 105c to blink with the blinking speed being increased as the remained time decreases, through the metering/focusing CPU 137. The self-timer circuit 83 inputs a clocking completion signal to the main CPU 20 upon the completion of the clocking. Then the main CPU 20 causes the CCD 132 to perform a shutter operation based on the clocking completion signal.

The communication control section 139 is provided with a communication port 107. The communication control section 139 functions to perform a data communication with the external apparatus by outputting an image signal of the object photographed by the camera 100 to the external apparatus such as a personal computer having a USB terminal and allowing such an external apparatus to input an image signal to the camera 100. The camera 100 has a function which is mimic to the switching function of a standard camera for photographing onto a roll of a film to switch between ISO film speeds 80, 100, 200, 400, 1600, and when a film speed of ISO 400 or more is selected, the amplification factor of an amplifier included in the white balance and γ processing section 133 switches to a high sensitivity mode in which the amplification factor is set to be higher than a predetermined amplification factor. The communication control section 139 disconnects the communication with an external apparatus during the photographing in a high sensitivity mode.

The camera 100 is further provided with a compressing/expanding/ID extracting section 143 and an IF section 144. The compressing/expanding/ID extracting section 143 reads out an image data stored in the buffer memory 135 through a bus line 142 and compresses the image data, which is stored in the memory card 200 via the I/F section 144. The compressing/expanding/ID extracting section 143 also extracts an identification number (ID) unique to the memory card 200 when it reads out an image data stored in the memory card 200, so that the compressing/expanding/ID extracting section 143 reads out the image data stored in the memory card 200, and expands and stores it in the buffer memory 135.

A Y/C signal stored in the buffer memory 135 is compressed by the compressing/expanding/ID extracting section 143 according to a predetermined format, and then is recorded to a removable medium such as the memory card 200 or built-in high-capacity storage media such as a hard disk (HDD) 75 via the I/F section 144 in a predetermined format (for example, Exif (Exchangeable Image File Format) file). A recording of a data to the hard disk (HDD) 75 or a reading of a data from the hard disk (HDD) 75 is controlled by the hard disk controller 74 in response to a command issued by the main CPU 20.

The camera 100 is also provided with the main CPU 20, an EEPROM 146, a YC/RGB conversion section 147, and a display driver 148. The main CPU 20 provides overall controls of the camera 100. The EEPROM 146 stores individual data and programs unique to the camera 100. The YC/RGB conversion section 147 converts a color video signal YC generated at the YC processing section 140 into a three-color RGB signal, and outputs the converted signal to the image display LCD 102 via the display driver 148.

The camera 100 has an AC adapter 48 and a power battery 68 removably attached thereto for an electric power supply from an AC power source. The power battery 68 may be a rechargeable secondary battery such as a Nickel-Cadmium battery, a nickel hydrogen battery, or a lithium ion battery. Alternatively, the power battery 68 may be a single use primary battery such as a lithium battery or an alkaline battery. The power battery 68 is mounted in a battery housing chamber (not shown) to be electrically connected to each circuit of the camera 100.

When the AC adapter 48 is mounted to the camera 100 for an electric power supply from the AC power source to the camera 100 via the AC adapter 48, even if the power battery 68 is mounted to the battery housing chamber, the electric power output from the AC adapter 48 has the priority to be supplied to each section of the camera 100 as a driving electric power. When the AC adapter 48 is not mounted to the camera 100 and the power battery 68 is mounted to the battery housing chamber, the electric power output from the power battery 68 is supplied to each section of the camera 100 as a driving electric power.

Although not shown, the camera 100 is provided with a backup battery other than the power battery 68 which is mounted to the battery housing chamber. The built-in backup battery may be a dedicated secondary battery which is charged by the power battery 68, for example. The backup battery supplies power to the basic functions of the camera 100 when the power battery 68 is not mounted to the battery housing chamber for its replacement or removal.

That is, a stoppage of power supply from the power battery 68 or the AC adapter 48 causes a switching circuit (not shown) to connect the backup battery to a RTC 15 for a power supply to the circuits. This enables a continuous power supply to the basic functions including the RTC 15 until the end of the useful life of the backup battery 29.

The RTC (Real Time Clock) 15 is a dedicated chip for clocking, and remains in continuous operation with the electric power supply from the backup battery even while a power supply from the power battery 68 or the AC adapter 48 is stopped.

The image display LCD 102 is provided with a back light 70 which illuminates a transmissive or semi-transmissive liquid crystal panel 71 from its rear surface side, and in a power saving mode, the main CPU 20 controls the brightness (luminance) of the back light 70 via a backlight driver 72, so that the power consumption by the back light 70 can be reduced. The power saving mode can be turned on/off when the information position specifying key 126 of the operation section 120 is pressed to cause the image display LCD 102 to display a menu screen and a predetermined operation is executed on the menu screen.

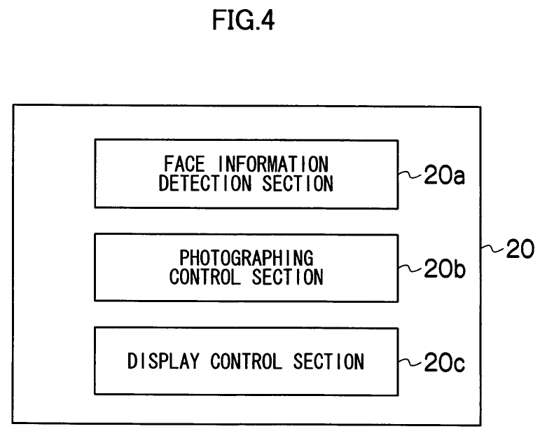

FIG. 4 is a block diagram conceptually showing a program according to a first embodiment, which is implemented by the main CPU 20. The main CPU 20 reads out the face detecting section 20a, the photographing control section 20b, and the display control section 20c which are the programs stored in a computer readable storage medium such as an EEPROM 146 or a hard disk 75 into the RAM 145 and executes them. These sections may be simply referred to a program.

The face detecting section 20a detects a face area including the face part of a person from the through image which is sequentially stored in the buffer memory 135 or an image from memory card 200. The detection of the face area may be performed by using the technology disclosed in Japanese Patent Application Laid-Open No. 9-101579 filed by the assignee of the present invention.

In the technology, it is determined if the color tone of each pixel in the photographed image is within the skin color range or not so that a skin color region and a non skin color region of the image are divided, and an edge in the image is detected so that every point of the image is categorized into an edge part or a non-edge part. Then, a region which locates in the skin color region, is consisted of the pixels categorized as the non-edge part, and is surrounded by the pixels determined to be the edge part is extracted as a face candidate region, and then it is determined if the extracted face candidate region corresponds to the face of the person or not, thereby a region is detected as a face area based on the determined result. Alternatively, a face area may be detected by using the method described in Japanese Patent Application Laid-Open No. 2003-209683 or Japanese Patent Application Laid-Open No. 2002-199221.

The face detecting section 20a also detects the position and size of a detected face area, the reliability of face detection (or accuracy), the angle of the tilt of a face area relative to the vertical direction as the reference, and a direction for rotating the image that makes a detected face area correctly oriented (e.g., a rotation direction which virtually positions a person's head at the top and his chin at the bottom, which is hereinafter denoted just as a rotation direction). A face area, the position and size of a face area, reliability of face detection, and a rotation direction are collectively referred to as face information. Face information can be detected by a method described in the Japanese Patent Application Laid-Open No. 2005-285035, for example. The face detecting section 20a stores detected face information in the buffer memory 135.

The photographing control section 20b is responsible for preparation for shooting such as AF and AE and/or control of recording image acquisition processing in response to half or full pressing of the release switch 104. It is also possible to perform AF and AE for a face area detected by the face detecting section 20a.

The display control section 20c sends commands to generate signals for displaying character and symbol information, such as shutter speed, aperture value, the number of remaining exposures, the date/time of shooting, a warning message, a graphical user interface (GUI) etc., to an OSD signal generation circuit 148a contained in the driver 148. A signal output by the OSD signal generation circuit 148a is combined with an image signal from the YC/RGB conversion section 147 as necessary to be supplied to the liquid crystal panel 71. As a result, a composite image which superimposes characters and the like over a through image or a reproduced image is displayed.

Referring to the flowchart of FIG. 5, the flow of image display processing executed by the CPU 20 will be described below. This processing starts in response to an “image rotation mode” being turned on through the operation section 120. The processing S1 through S3 is repeated until the “image rotation mode” is turned off.

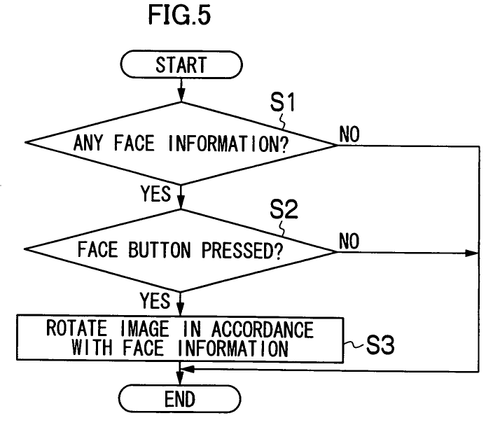

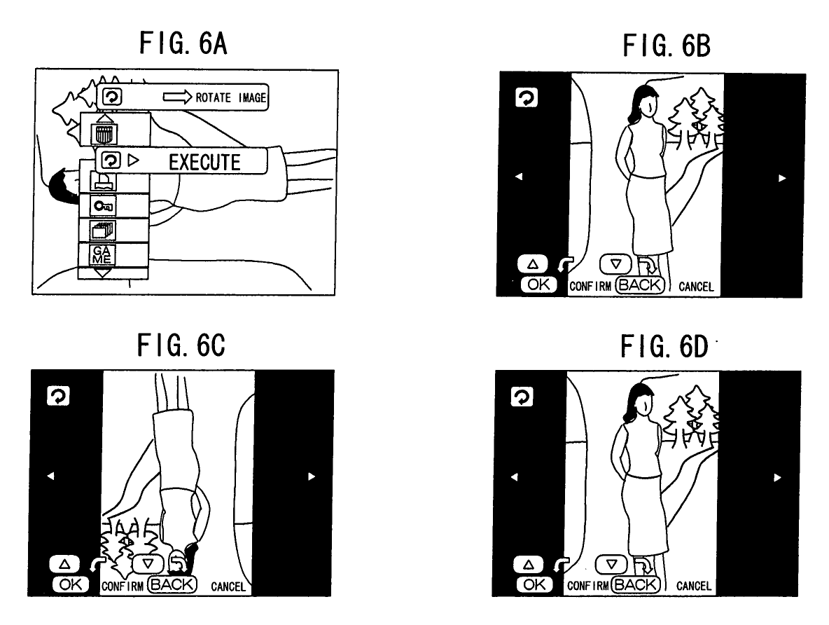

At S1, the display control section 20c displays a desired image read from the memory card 200 in the original orientation in which the image was taken (FIG. 6A). An image to be displayed can be freely selected through the operation section 120.

The face detecting section 20a detects face information from the displayed image. If the face detecting section 20a detects at least one piece of face information, the flow proceeds to S2.

If detection of face information is started upon display of an image, it may hinder prompt display processing of the image. Accordingly, if the face button 125 is pressed in the shooting mode, detection of face information is performed at that point, and any face information detected may be recorded in the memory card 200 being associated with a recording image (as header or tag information for the recording image, for instance). Then, at step S1, instead of detecting face information, reading of face information associated with the displayed image is attempted, and if it is determined that face information has been read out, the flow may proceed to S2.

At S2, the display control section 20c proceeds to S3 in response to detection of pressing of the face button 125.

At S3, the display control section 20c rotates the image in the rotation direction which is included in the face information detected by the face detecting section 20a by a predetermined angle (e.g., 90 degrees), and displays the rotated image (FIG. 6B).

If multiple pieces of face information are detected from one image, the image may be rotated in the rotation direction which is included in a piece of face information that has the highest index for a predetermined priority, such as face information that has the highest possibility of being a face or that has the largest face area.

It is also possible that the subject is not correctly oriented even after rotation in a rotation direction detected by the face detecting section 20a (FIG. 6C). In such a case, the image may be rotated by a predetermined angle (e.g., 90 degrees for each pressing of Up button and −90 degrees for each pressing of Down button) in accordance with manipulation of Up or Down button of the direction key 124 (FIG. 6D).

Also, even if the user rotates the image in a wrong direction with the Up or Down button, the user can put the image back into an orientation which correctly orients the subject's face in one pass by pressing the face button 125.

If the user judges that the image has been rotated in a correct direction, the user can press the information position specifying key 126 (an OK button) to save the rotation direction being associated with the image (saved in the header or tag information for the image, for example). Subsequently, the image will be displayed being rotated by a predetermined angle in that rotation direction from the original image position in which the image was taken. If the Left or Right button is pressed after image rotation, the same processing as when the information position specifying key 126 is pressed may be performed, and then the image of the previous or subsequent frame of the currently displayed image may be displayed.

In this manner, this embodiment rotates an image in a rotation direction that correctly orients a face in the image only after the face button 125 is pressed. This embodiment solves a drawback of conventional techniques: an image is automatically rotated in accordance with the result of face information detection, which may not conform to the user's intention.

### Second Embodiment

In the first embodiment, when the tilt of a subject's face does not result from portrait or landscape taking of the image but just from the tilt of his neck or the inclination of the ground where the subject stands, the image may be rotated in a rotation direction which is not intended by the user.

Accordingly, at S3 in the first embodiment, further determination is made as to whether or not the tilt of the subject's face is equal to or greater than 0° and less than 450, and if the tilt of the face is equal to or greater than 0° and less than 45°, the image is displayed as it is without being rotated. If the tilt of the face is greater than 45°, the image is rotated by a predetermined angle in a direction that correctly orients the face. Thus, even when the face has a subtle tilt, not a multiple of 90 degrees, such as 0, 90, 180 and 270 degrees, if the face area is already in a virtually correct orientation and the image needs not be rotated, the image can be left unrotated.

### Third Embodiment

When multiple pieces of face information are detected from one image, it is conceivable that if the image is rotated in a rotation direction according to any one piece of face information, it may be inappropriate for the correct orientation of the entire image.

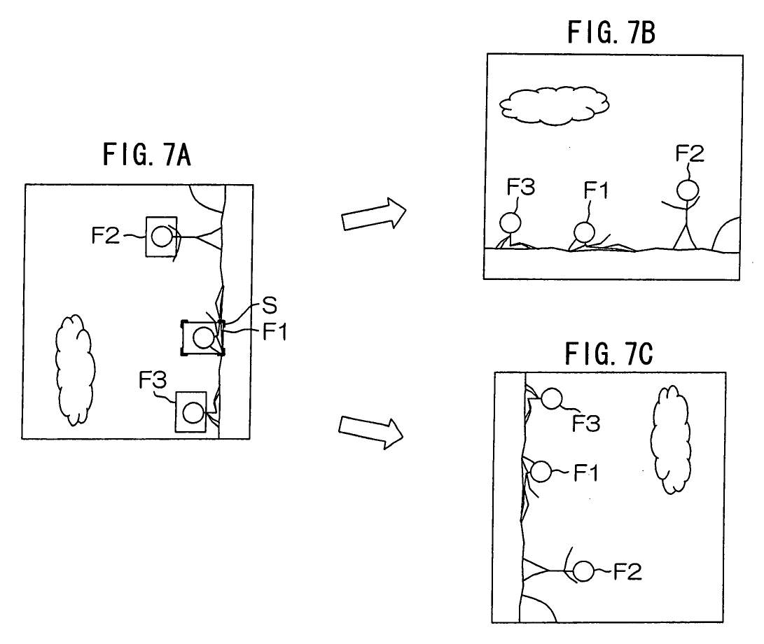

Specifically, as shown in FIG. 7A, consider an image that includes the face F1 of a subject who is lying on the ground as well as the faces F2 and F3 of subjects who are standing on the ground. If the image is rotated in a direction that makes the face F1 correctly oriented, the lying subject would look like standing, which is a result different from what the user originally intended (FIG. 7C).

Accordingly, this embodiment rotates the image in a rotation direction for the majority of subjects among detected rotation directions that can make the detected faces correctly oriented at S3 in the first embodiment.

Consequently, for example, the image shown in FIG. 7A is rotated in a rotation direction that virtually correctly orients the faces of the majority of the subjects, F2 and F3, which are intended by the user as subjects of the picture (FIG. 7B), which can prevent an inconvenience of making the lying subject look like standing.

### Fourth Embodiment

When there is a poster or a doll in an image, face information can be mistakenly obtained from it and the image might be rotated in a direction not intended by the user based on that face information.

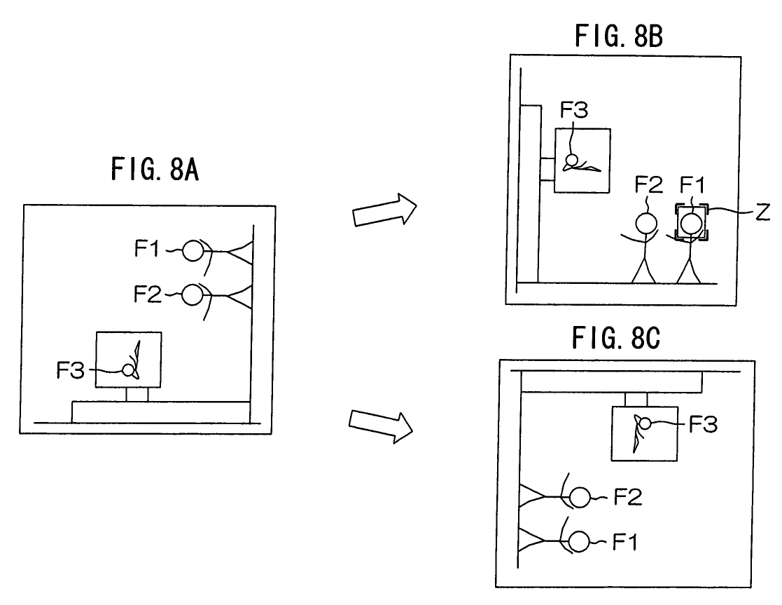

For example, as illustrated in FIG. 8A, when there is a person's face F3 that is drawn on a billboard in addition to persons' faces F1 and F2 within the angle of view and pieces of face information are extracted from F1 through F3 and if the face information for F1 has the highest priority, the image will be rotated in a direction that makes the face F1 correctly oriented but not F2 and F3 (FIG. 8C).

Thus, this embodiment further allows the user to select a desired face area from among detected face areas such as the operation of the direction key 124 and rotates the image in a rotation direction that makes the selected face area correctly oriented at S3 in the first embodiment. For instance, FIG. 8B shows that cursor Z for selecting one of the faces F1 to F3 selects the face F1 in accordance with the operation of the direction key 124 and that the image is rotated in a direction that makes the face F1 virtually correctly oriented. This can correctly orient a face desired by the user and also prevent the image from being rotated in a direction not intended by the user based on a wrong piece of face information.

### Fifth Embodiment

It goes without saying that combinations of the first embodiment and some or all of the second through fourth embodiments are also practicable.

What is claimed is:

1. An image display apparatus including a storage section which stores image data and a display section which is capable of displaying at least image data in the storage section, the image display apparatus comprising:
a face information detection section which detects a face information including a face area and the tilt of the face area from image data in the storage section;
an instruction section to which an instruction to start face rotation can be input; and
a display control section which, in response to input of an instruction to start face rotation to the instruction section, provides control so as to rotate the image data in a direction which makes the face area virtually correctly oriented based on the tilt of the face area detected by the face information detection section and displays the image data on the display section.

2. The image display apparatus according to claim 1, wherein
the display control section provides control so as to rotate the image data in a direction which makes the face area virtually correctly oriented and displays the image data on the display section only when the tilt of the face area exceeds a predetermined angle.

3. The image display apparatus according to claim 1, wherein
when the face information detection section detects a plurality of face areas and multiple pieces of face information, the display control section provides control so as to rotate the image data in a direction that virtually correctly orients the majority of the face areas and displays the image data on the display section.

4. The image display apparatus according to claim 2, wherein
when the face information detection section detects a plurality of face areas and multiple pieces of face information, the display control section provides control so as to rotate the image data in a direction that virtually correctly orients the majority of the face areas and displays the image data on the display section.

5. The image display apparatus according to claim 1, further comprising
a selection section which, when the face information detection section detects a plurality of face areas and multiple pieces of face information, allows selection of a desired one of the faces, wherein
the display control section provides control so as to rotate the image data in a direction which makes the face area selected through the selection section virtually correctly oriented and displays the image data on the display section.

6. The image display apparatus according to claim 2, further comprising
a selection section which, when the face information detection section detects a plurality of face areas and multiple pieces of face information, allows selection of a desired one of the faces, wherein
the display control section provides control so as to rotate the image data in a direction which makes the face area selected through the selection section virtually correctly oriented and displays the image data on the display section.

7. The image display apparatus according to claim 3, further comprising
a selection section which, when the face information detection section detects a plurality of face areas and multiple pieces of face information, allows selection of a desired one of the faces, wherein
the display control section provides control so as to rotate the image data in a direction which makes the face area selected through the selection section virtually correctly oriented and displays the image data on the display section.

8. The image display apparatus according to claim 4, further comprising
a selection section which, when the face information detection section detects a plurality of face areas and multiple pieces of face information, allows selection of a desired one of the faces, wherein
the display control section provides control so as to rotate the image data in a direction which makes the face area selected through the selection section virtually correctly oriented and displays the image data on the display section.

9. An image taking apparatus comprising the image display apparatus according to claim 1.

10. An image taking apparatus comprising the image display apparatus according to claim 2.

11. An image taking apparatus comprising the image display apparatus according to claim 3.

12. An image taking apparatus comprising the image display apparatus according to claim 4.

13. An image taking apparatus comprising the image display apparatus according to claim 5.

14. An image taking apparatus comprising the image display apparatus according to claim 6.

15. An image taking apparatus comprising the image display apparatus according to claim 7.

16. An image taking apparatus comprising the image display apparatus according to claim 8.

17. An image display method, comprising the steps of:
detecting face information including a face area and the tilt of the face area from image data;
inputting an instruction to start face rotation; and
in response to input of an instruction to start face rotation, rotating the image data in a direction which makes the face area virtually correctly oriented based on the detected tilt of the face area and displaying the image data.

18. An image display program for causing a computer to execute the steps of:
detecting face information including a face area and the tilt of the face area from image data;
inputting an instruction to start face rotation; and
in response to input of an instruction to start face rotation, rotating the image data in a direction which makes the face area virtually correctly oriented based on the detected tilt of the face area and displaying the image data.
